(19) United States
(12) Patent Application Publication
(10) Pub. No.: US 2017/0145913 A1
(43) Pub. Date: May 25, 2017

(54) CHECK VALVE FOR CONNECTING ROD OF VARIABLE COMPRESSION INTERNAL COMBUSTION ENGINE AND CONNECTING ROD WITH CHECK VALVE

(71) Applicant: Hilite Germany GmbH, Marktheidenfeld (DE)

(72) Inventors: Alexander Diehm, Wertheim - Dertingen (DE); Dietmar Schulze, Munzenberg (DE); Christian Jung, Eisenhüttenstadt (DE)

(21) Appl. No.: 15/245,732

(22) Filed: Aug. 24, 2016

(30) Foreign Application Priority Data
Nov. 25, 2015 (DE) DE10 2015120443.6
Nov. 25, 2015 (DE) DE102015120359.6
Jun. 3, 2016 (DE) DE102016110279.2

(51) Int. Cl. F02B 75/04; F16K 15/02

(52) U.S. Cl. CPC F02B 75/045; F16K 15/026

(57) ABSTRACT

A check valve of a connecting rod of a variable compression internal combustion engine, the connecting rod including at least one hydraulic chamber, wherein the hydraulic chamber of the connecting rod is connectable by the check valve with a supply connection or with a tank, wherein the check valve includes a valve housing and a valve closure element that is axially moveable along a longitudinal valve axis between an open position and a closed position, wherein the valve closure element is preloaded against a valve seat by a valve spring, characterized in that a mandrel shaped support element is provided which penetrates through the valve spring and which supports the valve spring in the open position of the valve closure element and in the closed position of the valve closure element. The invention also relates to a connecting rod with at least one check valve.

### RELATED APPLICATIONS

This application claims priority from and incorporates by reference German Patent Applications
DE 10 2015 120 359.6 filed on Nov. 25, 2015,
DE 10 2015 120 443.6 filed on Nov. 25, 2015, and
DE 10 2016 110 279.2 filed on Jun. 3, 2016.

### FIELD OF THE INVENTION

The invention relates to check valve for a connecting rod for a variable compression internal combustion engine including at least one hydraulic chamber wherein the hydraulic chamber of the connecting rod is connectable through the check valve with a supply connection or a tank wherein the check valve includes a pot shaped valve housing and a valve closure element that is axially moveable along a longitudinal axis of the valve wherein the valve closure element is preloaded against a valve seat by a valve spring. The invention also relates to a connecting rod including the check valve.

### BACKGROUND OF THE INVENTION

A high compression ratio has a positive influence upon efficiency of an internal combustion engine. Compression ratio is typically defined as a ratio of an entire cylinder volume before compression to a remaining cylinder volume after the compression. In internal combustion engines with external ignition in particular gasoline engines that have a fixed compression ratio, the compression ratio can only be selected at the most at a level where so called “knocking” of the internal combustion engine is avoided during full load operations. However, for the prevalent partial load operation of the internal combustion engine, thus for a lower cylinder charge the compression ratio can be selected higher without the “knocking” occurring. The important partial load operation of an internal combustion engine can be improved when the compression ratio is variably adjustable. In order to adjust the compression ratio for example systems with variable connecting rod length are known which actuate an eccentrical element adjustment device of a connecting rod using hydraulic switch valves.

A connecting rod of this type is known for example from DE 10 2013 107 127 A1 and includes an eccentrical element adjustment device for adjusting an effective piston rod length wherein the eccentrical element adjustment device includes an eccentrical element that cooperates with an eccentrical element lever and two pistons which are respectively movably supported in a hydraulic chamber and in which eccentrical element rods engaging the eccentrical element levers of the eccentrical element adjustment device are supported. An adjustment travel of the eccentrical element adjustment device is adjustable by a switch valve. An effective piston rod length is adjusted by a adjusting an adjustment travel. Thus, a compression of an internal combustion engine can be controlled. Check valves in the connecting rod respectively prevent a back flow of hydraulic fluid from the hydraulic chambers to a supply connection or a tank.

DE 10 2012 112 481 A1 discloses a check valve that is suitable for the purpose described supra.

### BRIEF SUMMARY OF THE INVENTION

Thus, it is an object of the invention to provide a novel, improved check valve and to furthermore provide an improved connecting rod with the check valve.

The object of the invention is achieved through a check valve of a connecting rod of a variable compression internal combustion engine, the connecting rod including at least one hydraulic chamber, wherein the hydraulic chamber of the connecting rod is connectable by the check valve with a supply connection or with a tank, wherein the check valve includes a valve housing and a valve closure element that is axially moveable along a longitudinal valve axis between an open position and a closed position, wherein the valve closure element is preloaded against a valve seat by a valve spring, characterized in that a mandrel shaped support element is provided which penetrates through the valve spring and which supports the valve spring in the open position of the valve closure element and in the closed position of the valve closure element. The invention also relates to a connecting rod with at least one check valve.

Advantageous embodiments and advantages of the invention can be derived from the description and the drawing figure.

The invention is based on a check valve for a piston rod for a variable compression of an internal combustion engine, the connecting rod including at least one hydraulic chamber, wherein the hydraulic chamber of the piston rod is connectable by the check valve with a supply connection or a tank and wherein the check valve includes a valve housing and a valve closure element that is movable along a valve longitudinal axis in an axial direction between an open position and a closed position wherein the valve closure element is preloaded by a valve spring against a valve seat.

It is proposed to provide a mandrel shaped support element which extends through the valve spring and by which, the valve spring is supported in the open position and also in the closed position of the valve closure element.

Advantageously the support of the valve spring prevents that the valve spring wedges or jams during opening or closing of the check valve. The support element advantageously extends at least from one end of the valve spring to an opposite end of the valve spring, this means over its entire length in a compressed operating condition of the valve spring and also in an extended operating condition of the valve spring. Advantageously the configuration of the check valve facilitates a stroke limitation of the valve closure element.

The invention facilitates a support of the valve spring over an entire length so that no intermediary space is created where the valve spring can escape under transversal forces and can thus wedge or be destroyed. Operational safety of the check valve is improved. The support element can be supported in the valve closure element. When the valve spring is arranged on the valve closure element forming the support element the valve closure element can be supported over its entire circumference. Thus a tilting of the valve closure element is excluded.

Advantageously the valve closure element is supported in the valve housing. Thus, a comparatively long support length is provided for the valve closure element so that a tilting or wedging of the valve closure element is excluded.

According to an advantageous embodiment of a first configuration of the check valve the mandrel shaped support element is configured fixated relative to the valve housing and provided so that it is insertable into the valve closure element.

Thus, it is advantageous for the support of the valve closure element when the valve closure element is provided as a valve closure piston which is preloaded by the valve spring against a base of the valve housing forming a valve seat, wherein the valve spring is supported by the support element of the retaining element supported in the valve closure piston.

According to an advantageous embodiment the valve housing can be configured pot shaped. This facilitates simple fabrication of the valve housing. Advantageously the valve housing can be a screw in housing which can be screwed into a connecting rod in a simple manner.

According to an advantageous embodiment the base of the valve housing can have an opening that is axially arranged with respect to a longitudinal valve axis wherein the opening is associated with the supply connection or the tank and closeable by the valve closure piston. This facilitates a simple fabrication of the supply connection of the valve housing.

According to an advantageous embodiment one or plural axial bore holes can be provided in the valve closure piston in order to facilitate a flow through of hydraulic fluid in a direction towards the hydraulic chamber when the valve closure element is opened. Through the axial bore holes in the valve closure piston complex radial bore holes in the valve housing can be omitted and the valve closure piston can be supported over its entire circumference.

According to an advantageous embodiment the valve closure element can have an interior in which the support element is supported and in which the support element is insertable when the valve closure element is open. This facilitates a reliable actuation of the valve closure element and a safe support of the valve spring over its entire length.

According to an advantageous embodiment the valve closure element can include one or plural radial bleed bore holes which lead into the axial bore holes. Advantageously the valve closure element can be bled towards the support element.

In an alternative second embodiment of the check valve the mandrel shaped support element can be configured so that it is moveable together with the valve closure element and so that the mandrel shaped support element is insertable into the valve housing or into a cover arranged in the valve housing.

Thus, advantageously the valve closure element can include the mandrel shaped support element which supports the valve spring, wherein the support element is supportable in the valve housing or in a cover arranged in the valve housing. The cover can be advantageously pressed into the valve housing.

According to an advantageously configuration of this alternative embodiment a closure element of the valve housing can include an opening that is axially arranged with respect to the longitudinal valve axis wherein the opening is associated with the supply connection or the tank and closeable by the valve closure element. This facilitates a simple configuration of the check valve.

According to an alternative advantageous configuration of the this alternative embodiment a base of the valve housing can include an opening that is axially arranged with reference to the longitudinal valve axis wherein the opening is associated with the supply connection or the tank and closeable by the valve closure element. This facilitates a simple configuration of the check valve.

According to an advantageous configuration of this embodiment one or plural axial bore holes can be provided in the valve closure element in order to facilitate a flow through of hydraulic fluid towards the hydraulic chamber when the valve closure element is opened.

As an alternative thereto the valve closure element can include one or plural indentations in order to facilitate a flow through of hydraulic fluid in a direction towards the hydraulic chamber when the valve closure element opens.

Steel, aluminum, aluminum alloys or a plastic material can be advantageously used as a material for the check valve in the recited embodiments.

According to another embodiment of the invention a connecting rod is proposed for a variable compression internal combustion engine, the connecting rod including at least one hydraulic chamber, wherein the hydraulic chamber is connectable by a check valve with one or plural of the features described supra with a supply connection or a bearing shell or a tank of the connecting rod.

The check valves of the connecting rod can be configured identical or one of the check valves can be configured according to the first described embodiment and another of the check valves can be configured according to the second embodiment.

### BRIEF DESCRIPTION OF THE DRAWINGS

Additional advantages of the invention can be derived from the subsequent drawing description. In the drawings an embodiment of the invention is schematically illustrated. The drawing, the description and the claims include several features in combination. A person skilled in the art will advantageously view the features individually and will combination them into additional useful combinations wherein:

FIG. 1 illustrates a connecting rod according to one embodiment of the invention;

FIG. 2 illustrates a check valve according to one embodiment of the invention in a longitudinal sectional view, wherein a valve spring is supported on a support element which is supported in a valve closure element;

FIG. 3 illustrates a check valve according to another embodiment of the invention in a longitudinal sectional view in which a valve spring is supported on a valve closure element configured as a support element;

FIG. 4 illustrates a check valve according to another embodiment of the invention in a longitudinal sectional view in which a valve spring is supported on a valve closure element configured as a support element; and

FIG. 5 illustrates a check valve according to another embodiment of the invention in a longitudinal sectional view in which a valve spring is supported on a valve closure element configured as a support element.

### DETAILED DESCRIPTION OF THE INVENTION

In the figures identical or like components are designated with identical reference numerals. The figures only illustrate exemplary embodiments and do not limit the spirit and scope of the invention.

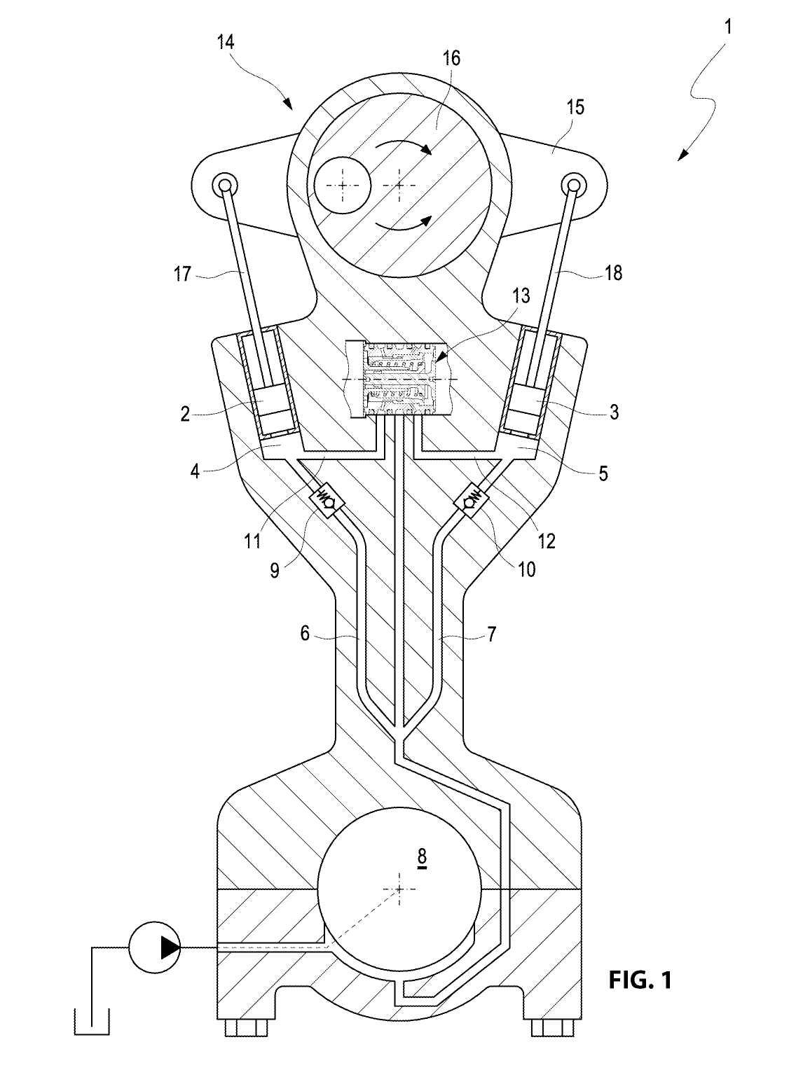

FIG. 1 illustrates a schematic representation of a connecting rod 1 according to the invention for a variable compression internal combustion engine including an eccentrical element adjustment device 14 for adjusting and effective connecting rod length. The eccentrical element adjustment device 14 includes an eccentrical element 16 cooperating with a one component or multicomponent eccentrical element lever 15 Thus, an adjustment travel of the eccentrical element adjustment device 14 is adjustable by a switch valve 13.

A rotation of the adjustable eccentrical element adjustment device 14 is initiated by mass forces and load forces of an internal combustion engine which impact the eccentrical element adjustment device during an operating stroke of the internal combustion engine. During an operating stroke the effective directions of the forces impacting the eccentrical element adjustment device change continuously. The rotating movement of the adjustment movement is supported by at least one piston 2, 3 which is loaded with hydraulic fluid in particular with motor oil and integrated in the connecting rod 1, or the at least one piston 2, 3 prevents a reset of the eccentrical element adjustment device 14 due to variable effective force directions of the forces impacting the eccentrical element adjustment device 14.

The pistons 2, 3 are operatively connected on both sides with the eccentrical element lever 15 by eccentrical element rods 17, 18. The pistons 2, 3 are movably arranged in hydraulic chambers 4, 5 and loaded with hydraulic fluid through check valves 8, 9 through hydraulic fluid conduits 6, 7 from the crank journal eye 8 wherein a configuration of the check valves is subsequently described in more detail. The check valves 9, 10 that are only schematically illustrated in FIG. 1 prevent a back flow of the hydraulic fluid from the hydraulic chambers 4, 5 into the hydraulic fluid conduits 6, 7 and into a bearing shell of the crank journal eye 8 or into a tank that is not described in more detail and facilitate suctioning hydraulic fluid into the hydraulic chambers 4, 5. The hydraulic chambers 4, 5 are connected with additional hydraulic fluid conduits 11, 12 which cooperate with the switch valve.

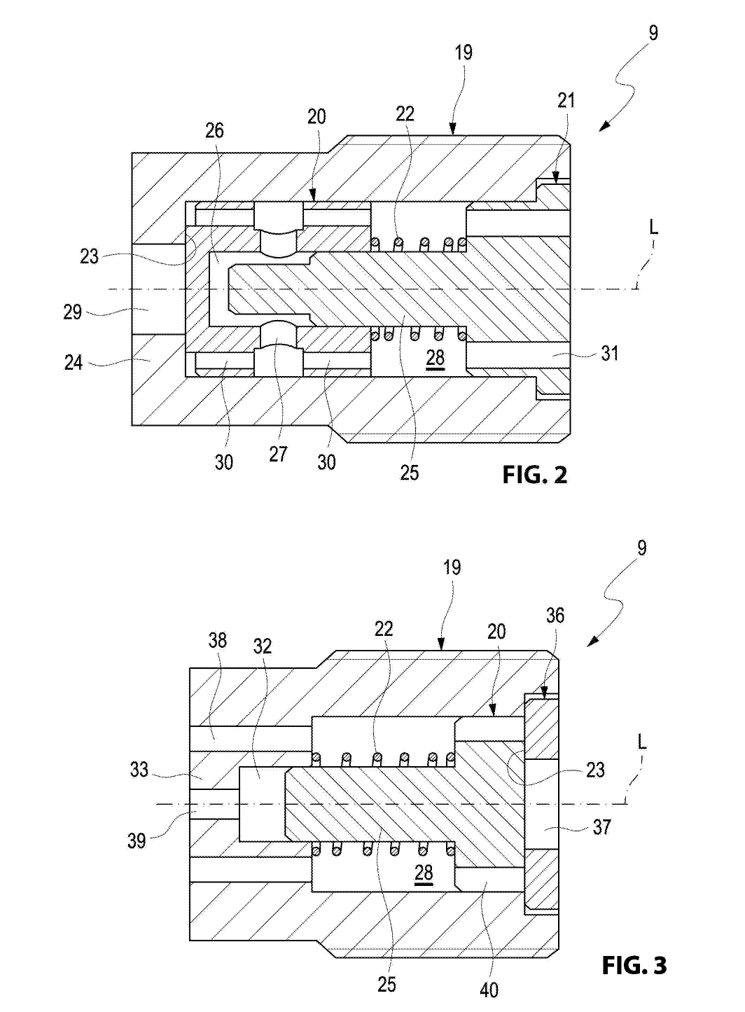

FIG. 2 illustrates a first embodiment of the first check valve 9 in a longitudinal sectional view, wherein the second check valve 10 can be configured identical so that only the check valve 9 is described infra.

The check valve 9 includes a pot shaped valve housing 19 and a valve closure element 20 that is axially movable along a longitudinal valve axis L wherein the valve closure element is preloaded against a valve seat 23 by a valve spring 22 that is arranged between the valve closure element 20 and a support element 21 that is attached in the valve housing 19.

The valve closure element 20 is configured as a valve closure piston which is supported in the valve housing 19 and preloaded by the valve spring 22 against a base 24 of the valve housing 19 forming a valve seat. The valve spring 22 is supported by a mandrel shaped support element 25 of the retaining element 21 wherein is supported in the valve closure piston 20. The mandrel shaped support element 25 which penetrates the valve spring 22 over its entire length is fixated at the valve housing 19 in this embodiment and configured so that it the valve closure element 20. Moving the valve closure piston 30 inserts a free end the support element 25 into an interior space 26 of the valve closure piston 20. One or plural radial bleed bore holes 27 of the valve closure piston 20 thus facilitate an exchange of hydraulic fluid between an interior space 26 and an interior space 28 of the valve housing 19.

The base 24 of the valve housing 19 includes an opening 29 that is axially arranged with respect to the longitudinal valve axis L wherein the opening is associated with the supply connection or the tank (not illustrated) and closeable by the valve closure piston 20.

When more hydraulic fluid is suctioned in the valve closure piston 20 is opened against a spring force of the valve spring 22. The hydraulic fluid suctioned in through the opening 29 can flow through plural axial bore holes 30 of the valve closure piston 20 through an interior space of the valve housing 19 and axial openings 31 in the retaining element 21 in a direction towards the hydraulic chamber 4 (FIG. 1). As evident from FIG. 2 the bleed bore holes 27 lead into the axial bore holes 30 of the valve closure piston 20. The bleed bore holes 27 extend to an outside of the valve closure piston 20 for fabrication reasons.

The configuration of the check valves 9, 10 improved according to the invention facilitates supporting the valve spring 22 over its entire length so that no intermediary space can be created where the valve spring 22 can move due to the transversal forces so that it could be destroyed.

Furthermore it is advantageous for the described embodiment of the valve closure element 20 that radial bore holes in the valve housing 19 can be omitted since the valve housing 19 is advantageously provided threaded into the connecting rod 1. Thus, it is further advantageous that the valve closure element 20 can be supported over its entire circumference. A tilting is thus precluded.

FIGS. 3-5 illustrate variants of an alternative embodiment of the first check valve 9 in a longitudinal sectional view wherein the second check valve 10 can be configured identical so that only the check valve 9 is described infra.

The check valve 9 includes a valve housing 19 and a valve closure element 20 that is axially moveable along a longitudinal valve axis L wherein the valve closure element is preloaded against a valve seat 23 by a valve spring 22.

The valve closure element 20 is supported in the valve housing 19 and includes a mandrel shaped support element 20 which penetrates the valve spring 22 over its entire length so that the valve spring 22 is supported. Thus, the mandrel shaped support element 25 is configured so that it is moveable together with the valve closure element 20 and so that it is insertable into the valve housing 19 or into a cover 35 arranged in the valve housing 19.

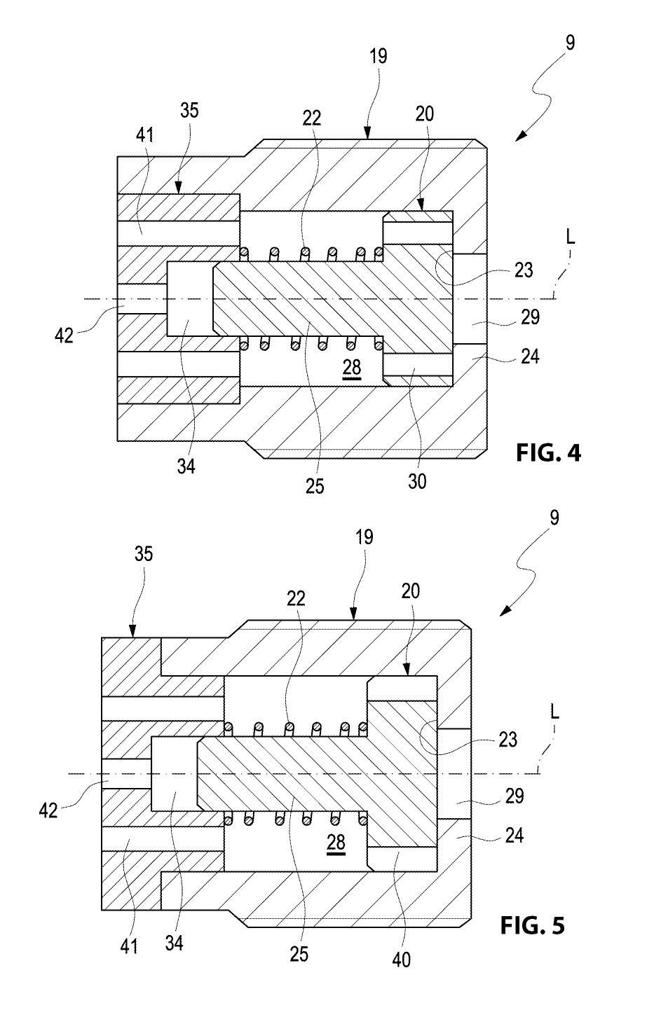

As evident from FIG. 3-5 the support element 25 can either be supported in a recess 32 of a base 33 of the valve housing 19 (FIG. 3) or in a recess 34 of a cover 35 (FIG. 4 and 5) The support element 25 can be configured as a cylinder or as a plate.

As evident from FIG. 3 the valve seat 23 is arranged at a closure element 36 attached in the valve housing 19 wherein the closure element includes an opening 37 which is associated with the supply connection or the tank (not illustrated) and which is closeable by the valve closure element 20. The base 33 includes openings 38 for a flow through of the hydraulic fluid in a direction towards the hydraulic chamber 4 (FIG. 1). Furthermore a ventilation bore hole 39 is provided in the portion of the recess 32.

The valve closure element 20 can include indentations or recesses 40 (FIG. 3 and 5) or bore holes 30 (FIG. 4) at an outside to facilitate a flow through of the hydraulic fluid.

According to FIGS. 4 and 5 the base 24 of the valve housing 19 includes an opening 29 that is axially arranged with respect to the longitudinal valve axis L wherein the opening is associated with the supply connection or the tank or closeable by the valve closure element 20.

The cover 35 includes openings 41 facilitating a flow through of the hydraulic fluid in a direction towards the hydraulic chamber 4 (FIG. 1). Furthermore a ventilation bore hole 32 is provided in a portion of the recess 34.

The improved configuration of the check valves 9, 10 according to the invention facilitates a support of the valve spring 22 over its entire length so that no intermediary space s provided where the valve spring 22 can escape under transversal forces and thus be destroyed.

It is furthermore advantageous in the described embodiment of the valve closure element 20 that radial bore holes in the valve housing 19 can be omitted since the valve housing is advantageously provided threaded into the connecting rod 1. The support element 25 improves the support of the valve closure element 20.

What is claimed is:

1. A check valve for a connecting rod of a variable compression internal combustion engine, the connecting rod comprising:
at least one hydraulic chamber,
wherein the at least one hydraulic chamber of the connecting rod is connectable by the check valve with a supply connection or with a tank,
wherein the check valve includes a valve housing and a valve closure element that is axially moveable along a longitudinal valve axis between an open position and a closed position,
wherein the valve closure element is preloaded against a valve seat by a valve spring,
wherein a mandrel shaped support element is provided which extends through the valve spring and which supports the valve spring in the open position of the valve closure element and in the closed position of the valve closure element.

2. The check valve according to claim 1, wherein the valve closure element is supported in the valve housing.

3. The check valve according to claim 1, wherein the mandrel shaped support element is fixated at the valve housing and configured insertable into the valve closure element.

4. The check valve according to claim 1,
wherein the valve closure element is configured as a valve closure piston which is preloaded by the valve spring against a base of the valve housing configured as a valve seat,
wherein the valve spring is supported by the support element of a retaining element, and
wherein the support element is supported in the valve closure piston.

5. The check valve according to claim 1, wherein the valve housing is configured pot shaped.

6. The check valve according to claim 1,
wherein a base of the valve housing includes an opening that is axially arranged with respect to the longitudinal valve axis, and
wherein the opening is associated with the supply connection or the tank and closable by the valve closure piston.

7. The check valve according to claim 1,
wherein one or plural axial bore holes are provided in the valve closure piston so that a flow through of hydraulic fluid towards the at least one hydraulic chamber is facilitated when the valve closure element is opened.

8. The check valve according to claim 1, wherein the valve closure element includes an interior space in which the support element is supported and into which the support element is insertable when the valve closure element is opened.

9. The check valve according to claim 7,
wherein the valve closure element includes an interior space in which the support element is supported and into which the support element is insertable when the valve closure element is opened, and
wherein the valve closure element includes one or plural radial bleed bore holes which open into the axial bore holes.

10. The check valve according to claim 1, wherein the mandrel shaped support element is movable together with the valve closure element and insertable into the valve housing or into a cover arranged in the valve housing.

11. The check valve according to claim 10,
wherein the valve closure element includes the mandrel shaped support element which supports the valve spring, and
wherein the mandrel shaped support element is supported in the valve housing or in the cover arranged in the valve housing.

12. The check valve according to claim 11, wherein a closure element of the valve housing includes an opening that is axially arranged with respect to the longitudinal valve axis, and
wherein the opening is associated with the supply connection or the tank and closable by the valve closure element.

13. The check valve according to claim 11, wherein a base of the valve housing includes an opening that is axially arranged with respect to the longitudinal valve axis which opening is associated with the supply connection or the tank and which is closable by the valve closure element.

14. The check valve according to claim 11, wherein one or plural axial bore holes are provided in the valve closure element so that a flow through of hydraulic fluid towards the hydraulic chamber is facilitated when the valve closure element is opened.

15. The check valve according to claim 11, wherein the valve closure element includes one or plural indentations which facilitate a flow through of hydraulic fluid towards the hydraulic chamber when the valve closure element is opened.

16. A connecting rod for a variable compression internal combustion engine comprising:
at least one hydraulic chamber,
wherein the at least one hydraulic chamber is connectable by the check valve according to claim 1 with the supply connection or a bearing shell or a tank of the connecting rod.
